(19) United States
(12) Patent Application Publication
(10) Pub. No.: US 2026/0016290 A1
(43) Pub. Date: Jan. 15, 2026

(54) X-RAY FITTING ANALYSIS METHOD AND X-RAY FITTING ANALYSIS SYSTEM BASED ON MULTI-PHYSICS VARIABLE MODEL

(71) Applicant: NanoSeex Inc., Hsinchu County (TW)

(72) Inventors: KAI-HAO CHANG, Hsinchu County (TW); TSUNG-HSIEN HAN, Hsinchu County (TW); CHUN-TING LIU, Hsinchu County (TW); PO-CHING HE, Hsinchu County (TW); PO-TSANG WU, Hsinchu County (TW)

(21) Appl. No.: 19/007,568

(22) Filed: Jan. 2, 2025

(30) Foreign Application Priority Data
Jul. 15, 2024 (TW) 113126376

(51) Int. Cl. G01B 15/02; G01B 15/08; G01N 9/00

(52) U.S. Cl. CPC G01B 15/02; G01B 15/08; G01N 9/00

(57) ABSTRACT

An X-ray fitting analysis method and an X-ray fitting analysis system based on a multi-physics variable model. The X-ray fitting analysis method includes: obtaining multiple X-ray measurement signals of an inspection target by an X-ray measurement apparatus; establishing multiple fitting models according to a target architecture; performing an initial fitting procedure to generate multiple initial fitting results and multiple initial parameter ranges; performing a first co-fitting procedure to obtain multiple first fitting results that satisfy a first fitting condition; performing, according to a data type of the first fitting results, a classification procedure to generate multiple classification fitting results; counting to obtain multiple classification parameter ranges; and performing a second co-fitting procedure to obtain multiple second fitting results that satisfy a second fitting condition and respectively correspond to multiple structural parameters.

### CROSS-REFERENCE TO RELATED PATENT APPLICATION

This application claims the benefit of priority to Taiwan Patent Application No. 113126376, filed on Jul. 15, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an analysis method and an analysis system, and more particularly to an X-ray fitting analysis method and an X-ray fitting analysis system based on a multi-physics variable model.

### BACKGROUND OF THE DISCLOSURE

A conventional three-dimensional NOT-AND (hereinafter referred to as 3D NAND) flash memory usually has a high aspect ratio structure with repetitive stacking and interconnection along a vertical direction. As such, channel hole etching is the most critical process in the technical development and manufacturing of the 3D NAND flash memory, and any abnormality may affect subsequent processes. For example, deposition in barrier, trap, and tunnel layers, channel formation, or other abnormalities will eventually affect function and reliability of components. In addition, uniformity is extremely important for process control.

In order to precisely control process parameters, a critical dimension (CD) of each word line (WL) in a product is measured. However, in the existing measurement approaches (e.g., a transmission electron microscope (TEM) that inspects cross-sections or a critical dimension scanning electron microscope (CD-SEM)), measurement is mostly performed in a destructive manner. While OCD (optical critical dimension) spectral measurement is the main non-destructive approach for measuring the critical dimension (CD), challenges may occur with an increase in layer number.

### SUMMARY OF THE DISCLOSURE

In response to the above-referenced technical inadequacies, the present disclosure provides an X-ray fitting analysis method and an X-ray fitting analysis system based on a multi-physics variable model.

In order to solve the above-mentioned problems, one of the technical aspects adopted by the present disclosure is to provide an X-ray fitting analysis method based on a multi-physics variable model. The X-ray fitting analysis method includes: performing measurement by one or more X-ray measurement apparatuses to obtain a plurality of X-ray measurement signals of an inspection target; and configuring a processing device to execute the following processes. The following processes include: establishing a plurality of fitting models according to a target architecture of the inspection target, in which the target architecture is defined to include a plurality of structural parameters; performing an initial fitting procedure on the plurality of X-ray measurement signals respectively by the plurality of fitting models, so as to generate a plurality of initial fitting results of the plurality of structural parameters; counting the plurality of initial fitting results to generate a plurality of initial parameter ranges; performing, according to the plurality of initial parameter ranges, a first co-fitting procedure on the plurality of X-ray measurement signals respectively by the plurality of fitting models, so as to obtain a plurality of first fitting results that satisfy a first fitting condition; performing, according to a data type of the plurality of first fitting results, a classification procedure on the plurality of first fitting results, so as to generate a plurality of classification fitting results; counting the plurality of classification fitting results to obtain a plurality of classification parameter ranges; and performing, according to the plurality of classification parameter ranges, a second co-fitting procedure on the plurality of X-ray measurement signals respectively by the plurality of fitting models, so as to obtain a plurality of second fitting results that satisfy a second fitting condition and respectively correspond to the plurality of structural parameters. Here, the first co-fitting procedure is to perform fitting for a predetermined range of the target architecture, and the second co-fitting procedure is to perform a fitting analysis for an entire range of the target architecture.

In order to solve the above-mentioned problems, another one of the technical aspects adopted by the present disclosure is to provide an X-ray fitting analysis method based on a multi-physics variable model. The X-ray fitting analysis method includes: performing measurement by one or more X-ray measurement apparatuses to obtain a plurality of X-ray measurement signals of an inspection target; and configuring a processing device to execute the following processes. The following processes include: establishing a plurality of fitting models according to a target architecture of the inspection target, in which the target architecture is defined to include a plurality of structural parameters; performing an initial fitting procedure on the plurality of X-ray measurement signals respectively by the plurality of fitting models, so as to generate a plurality of initial fitting results of the plurality of structural parameters; counting the plurality of initial fitting results to generate a plurality of initial parameter ranges; generating a set of first to-be-verified parameters according to the plurality of initial parameter ranges; inputting the set of first to-be-verified parameters into the plurality of fitting models to verify an accuracy of the set of first to-be-verified parameters, and adjusting the set of first to-be-verified parameters according to the accuracy and the plurality of initial parameter ranges until an optimization condition is satisfied, so as to obtain an optimized parameter set; setting a plurality of weights for the optimized parameter set, and applying the plurality of weights to the optimized parameter set before the optimized parameter set is input into the plurality of fitting models, so as to verify a weight accuracy of the plurality of weights; and adjusting the plurality of weights according to the weight accuracy until the weight accuracy satisfies a weight optimization condition, and applying the plurality of weights that satisfy the weight optimization condition to the optimized parameter set, so as to generate a weight-optimized parameter set.

In order to solve the above-mentioned problems, yet another one of the technical aspects adopted by the present disclosure is to provide an X-ray fitting analysis system based on a multi-physics variable model, which includes one or more X-ray measurement apparatuses and a processing device. The one or more X-ray measurement apparatuses are configured to perform measurement on an inspection target for obtaining a plurality of X-ray measurement signals. The processing device is configured to execute processes of: establishing a plurality of fitting models according to a target architecture of the inspection target, in which the target architecture is defined to include a plurality of structural parameters; performing an initial fitting procedure on the plurality of X-ray measurement signals respectively by the plurality of fitting models, so as to generate a plurality of initial fitting results of the plurality of structural parameters; counting the plurality of initial fitting results to generate a plurality of initial parameter ranges; performing, according to the plurality of initial parameter ranges, a first co-fitting procedure on the plurality of X-ray measurement signals respectively by the plurality of fitting models, so as to obtain a plurality of first fitting results that satisfy a first fitting condition; performing, according to a data type of the plurality of first fitting results, a classification procedure on the plurality of first fitting results, so as to generate a plurality of classification fitting results; counting the plurality of classification fitting results to obtain a plurality of classification parameter ranges; and performing, according to the plurality of classification parameter ranges, a second co-fitting procedure on the plurality of X-ray measurement signals respectively by the plurality of fitting models, so as to obtain a plurality of second fitting results that satisfy a second fitting condition and respectively correspond to the plurality of structural parameters. Here, the first co-fitting procedure is to perform fitting for a predetermined range of the target architecture, and the second co-fitting procedure is to perform a fitting analysis for an entire range of the target architecture.

In order to solve the above-mentioned problems, still another one of the technical aspects adopted by the present disclosure is to provide an X-ray fitting analysis system based on a multi-physics variable model, which includes one or more X-ray measurement apparatuses and a processing device. The one or more X-ray measurement apparatuses perform measurement on an inspection target to obtain a plurality of X-ray measurement signals. The processing device is configured to execute processes of: establishing a plurality of fitting models according to a target architecture of the inspection target, in which the target architecture is defined to include a plurality of structural parameters; performing an initial fitting procedure on the plurality of X-ray measurement signals respectively by the plurality of fitting models, so as to generate a plurality of initial fitting results of the plurality of structural parameters; counting the plurality of initial fitting results to generate a plurality of initial parameter ranges; generating a set of first to-be-verified parameters according to the plurality of initial parameter ranges; inputting the set of first to-be-verified parameters into the plurality of fitting models to verify an accuracy of the set of first to-be-verified parameters, and adjusting the set of first to-be-verified parameters according to the accuracy and the plurality of initial parameter ranges until an optimization condition is satisfied, so as to obtain an optimized parameter set; setting a plurality of weights for the optimized parameter set, and applying the plurality of weights to the optimized parameter set before the optimized parameter set is input into the plurality of fitting models, so as to verify a weight accuracy of the plurality of weights; and adjusting the plurality of weights according to the weight accuracy until the weight accuracy satisfies a weight optimization condition, and applying the plurality of weights that satisfy the weight optimization condition to the optimized parameter set, so as to generate a weight-optimized parameter set.

Therefore, in the X-ray fitting analysis method and the X-ray fitting analysis system based on the multi-physics variable model provided by the present disclosure, the cursory first co-fitting procedure is performed to classify fitting results and limit ranges of the structural parameters before the detailed second co-fitting procedure is performed. When the inspection target has a significant amount of material layers, a computation amount can be reduced while a certain fitting accuracy can be maintained, thereby ensuring the stability of the fitting models.

Furthermore, in the X-ray fitting analysis method and the X-ray fitting analysis system based on the multi-physics variable model provided by the present disclosure, a weight mechanism is further implemented, and the weights are optimized, so as to increase an optimization speed and reduce a degree of divergence of the fitting results.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a first schematic view of an X-ray fitting analysis system based on a multi-physics variable model according to a first embodiment of the present disclosure;

FIG. 2 is a second schematic view of the X-ray fitting analysis system based on the multi-physics variable model according to the first embodiment of the present disclosure;

FIG. 3 is a flowchart of an X-ray fitting analysis method based on the multi-physics variable model according to the first embodiment of the present disclosure;

FIG. 4 and FIG. 5 are a first schematic view and a second schematic view of a target architecture of an inspection target according to the first embodiment of the present disclosure, respectively;

FIG. 6 is a set of curve diagrams showing two initial fitting results according to the first embodiment of the present disclosure;

FIG. 7 is a set of curve diagrams showing two first fitting results obtained after a first co-fitting procedure according to the first embodiment of the present disclosure;

FIG. 8 shows classification fitting results obtained through a trained classification model according to the first embodiment of the present disclosure;

FIG. 9 shows two second fitting results through a second co-fitting procedure according to the first embodiment of the present disclosure;

FIG. 10 is a schematic diagram showing a comparison between an X-ray fitting analysis result according to the first embodiment of the present disclosure and a fitting analysis result of a single-physics model;

FIG. 11 is a flowchart of the X-ray fitting analysis method based on the multi-physics variable model according to a second embodiment of the present disclosure;

FIG. 12 is a schematic diagram showing a first iteration in step S26 according to the second embodiment of the present disclosure; and

FIG. 13 is a schematic diagram showing a second iteration in step S26 according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

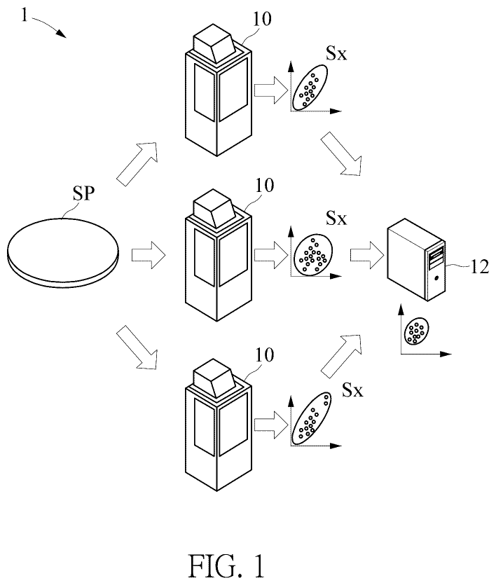

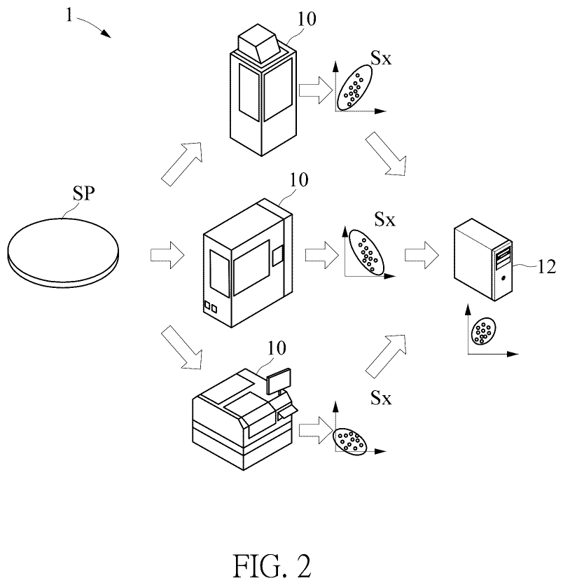

FIG. 1 is a first schematic view of an X-ray fitting analysis system based on a multi-physics variable model according to a first embodiment of the present disclosure. FIG. 2 is a second schematic view of the X-ray fitting analysis system based on the multi-physics variable model according to the first embodiment of the present disclosure. As shown in FIG. 1 and FIG. 2, the first embodiment of the present disclosure provides an X-ray fitting analysis system 1 based on a multi-physics variable model, which includes a plurality of X-ray measurement apparatuses 10 and a processing device 12.

In the present embodiment, the X-ray measurement apparatus 10 includes an X-ray generator, an X-ray optical component assembly, an X-ray detector, and a sample carrier. The X-ray generator is configured to generate X-ray beams having a predetermined energy. The X-ray optical component assembly is configured to guide and focus the X-ray beams on an inspection target SP, and the X-ray detector is configured to receive signals generated after the inspection target SP is irradiated by the X-ray beams. However, the present disclosure is not limited thereto. The X-ray measurement apparatus 10 is configured to perform measurement on the inspection target SP for obtaining a plurality of X-ray measurement signals Sx. As shown in FIG. 1, there is more than one X-ray measurement apparatus 10. However, in practical application, one X-ray measurement apparatus 10 can be configured to measure the inspection target SP with a plurality of different measurement conditions. Alternatively, as shown in FIG. 2, different X-ray measurement apparatuses 10 can be configured to measure the inspection target SP. In the present embodiment, these X-ray measurement apparatuses 10 can include an X-ray reflectivity (XRR) measurement apparatus, an X-ray fluorescence (XRF) spectrometer, a small-angle X-ray scattering (SAXS) measurement apparatus, an X-ray diffractometer (XRD), or other apparatuses that are capable of using an X-ray as a light source for measurement.

Each X-ray measurement signal Sx can include one or more of a transmittance pattern, a reflection pattern, a diffraction pattern, and a scattering pattern. For example, the X-ray measurement signal Sx includes the reflection pattern. After an X-ray is incident into the inspection target SP by a plurality of predetermined angles, a receiver in the X-ray measurement apparatus 10 receives an intensity of the X-ray generated after reflection, and structural parameters of the inspection target SP can be obtained by performing a fitting analysis on X-ray measurement signals. The structural parameters can include, for example, one or more of a thickness, a density, and a roughness.

The processing device 12 can be, for example, a computer system that includes a processor and a memory, and is configured to execute a stored instruction set or program code for obtaining the X-ray measurement signals and performing the fitting analysis. In addition, the processing device 12 can control the X-ray measurement apparatus 10 to perform a corresponding measurement procedure on the inspection target SP.

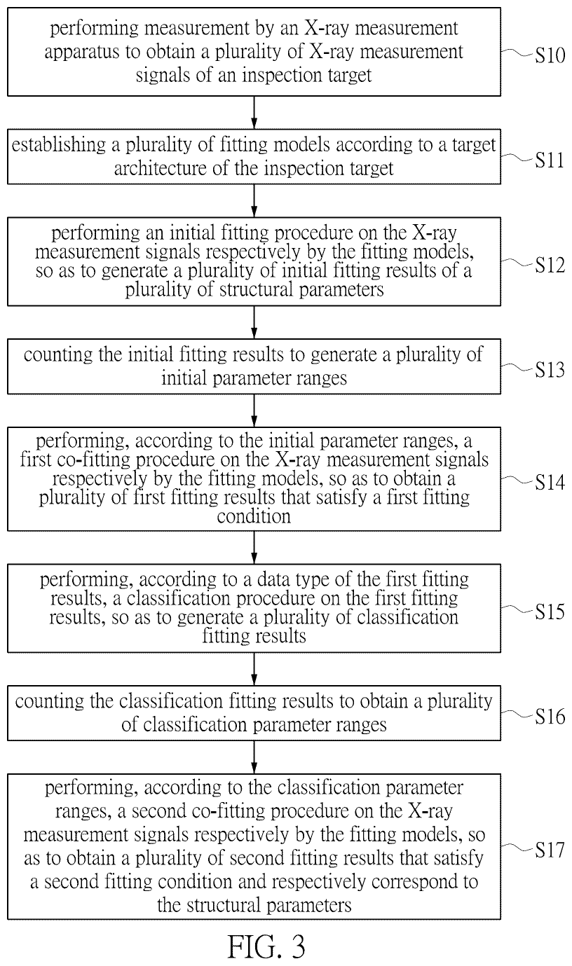

Reference is made to FIG. 3, which is a flowchart of an X-ray fitting analysis method based on the multi-physics variable model according to the first embodiment of the present disclosure. As shown in FIG. 3, the X-ray fitting analysis method can include the following processes.

Step S10: performing measurement by an X-ray measurement apparatus to obtain the X-ray measurement signals of an inspection target. In this step, a quantity of the X-ray measurement apparatus 10 can be one or more than one.

Then, the processing device 12 is configured to execute the following processes.

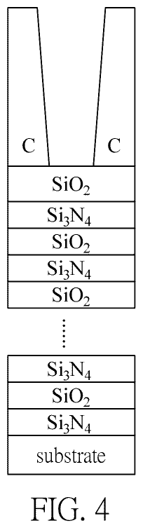

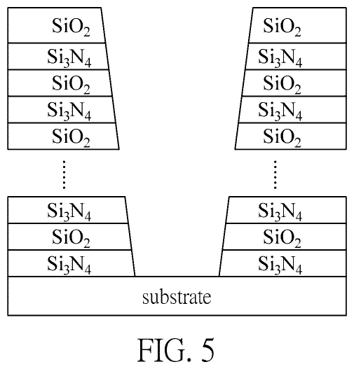

Step S11: establishing a plurality of fitting models according to a target architecture of the inspection target. FIG. 4 and FIG. 5 are a first schematic view and a second schematic view of the target architecture of the inspection target according to the first embodiment of the present disclosure, respectively. In step S11, a target architecture of the inspection target SP can be, for example, a sample in which a pattern on a carbon film is yet to be transferred to a structure having multiple material layers (as shown in FIG. 4), or a sample in which the pattern on the carbon film is already transferred to the structure having multiple material layers and the carbon film is removed (as shown in FIG. 5). As such, the target architecture includes more than one material layer, and is defined to include more than one structural parameter. The structural parameters can include, for example, the thickness, the density, or the roughness of each material layer.

Step S12: performing an initial fitting procedure on the X-ray measurement signals respectively by the fitting models, so as to generate a plurality of initial fitting results of the structural parameters.

The initial fitting procedure includes: using the processing device 12 to operate a plurality of electromagnetic wave computation engines that correspond to the fitting models, and performing a spectrum fitting analysis on a corresponding one of the X-ray measurement signals Sx according to the target architecture, so as to obtain a corresponding one of the initial fitting results. The electromagnetic wave computation engines can include, for example, one or more of a finite-difference time-domain (FDTD) algorithm, a distorted wave born approximation (DWBA) algorithm, a rigorous coupled-wave analysis (RCWA) algorithm, a discrete dipole approximation (DDA) algorithm, and a boundary element method (BEM).

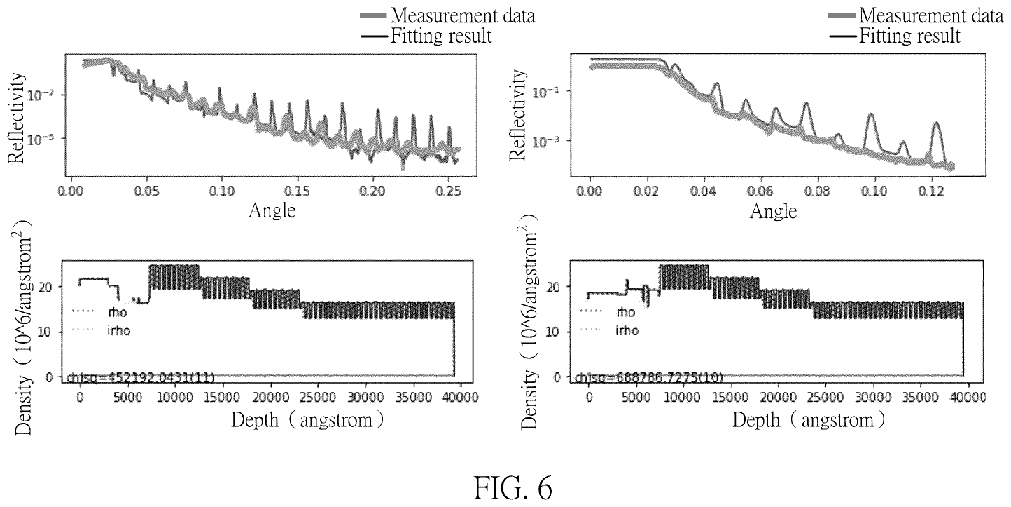

For example, by using the above-mentioned electromagnetic wave computation engines, fitting can be performed on data measured after incidence of X-ray beams having different energies, so as to obtain the structural parameters of the target architecture and a corresponding accuracy. The accuracy includes specific structural parameters, such as a variance and an error amount of the density. The variance can be, for example, an average of the structural parameters generated after several times of fitting divided by a standard deviation. The error amount can be described by a cost function, and is used to measure a matching degree between a model and fitting target data. The cost function can be, for example, a mean squared error (MSE) between a fitting result and the fitting target data. Hence, for a fitting model having an N number of layers, an N number of variances (i.e., a density average divided by a density standard deviation in each of an N number of material layers) in a set of structural parameters and one error amount can be generated after one electromagnetic wave computation engine is used to perform several times of initial fitting. When there are an M number of fitting models, an M number of electromagnetic wave computation engines are respectively used to perform fitting, so as to generate an M number of error amounts and M sets of N variances. Reference is made to FIG. 6, which is a set of curve diagrams showing two initial fitting results according to the first embodiment of the present disclosure. The two upper curve diagrams of FIG. 6 show relationships between angles and the X-ray measurement signals Sx and between the angles and reflectivities obtained by fitting. In the two lower curve diagrams of FIG. 6, relationships between densities (which are divided into a real part rho and an imaginary part irho) and depths are shown, and data on a lower part thereof indicates the accuracy in the form of mean squared error (labelled as chisq). The respective accuracies are approximately 452192 and 688786 (with omission of decimals).

Step S13: counting the initial fitting results to generate a plurality of initial parameter ranges.

After multiple sets of the structural parameters are obtained through initial fitting, initial counting can be performed to obtain the initial parameter range for each structural parameter. It should be noted that, with an increase in layer number of the inspection target SP, the fitting model may become overly complicated due to excessive floating parameters, thereby resulting in exponential growth of computation time. In practice, for a 3D NAND structure, simple modeling and fitting are not feasible. Since a depth of a channel hole is doubled at each node transition, the sensitivity of a critical dimension of a bottom portion will be too weak. At the same time, critical dimensions of two adjacent word lines may have the same spectral responsivity and are indistinguishable, thereby causing the problem of modeling correlation. While the stability of a model can be enhanced by using a critical dimension of a bottom layer together with a critical dimension of a middle layer in a simplified manner, such a process may lead to a poor result correctness of the critical dimension of the bottom layer. Moreover, when there is a change in the relationship between the critical dimension of the middle layer and the critical dimension of the bottom layer, the accuracy will be further decreased. Therefore, in the present disclosure, analysis is performed by adopting a novel fitting method, so as to reduce a computation amount and improve the accuracy.

Step S14: performing, according to the initial parameter ranges, a first co-fitting procedure on the X-ray measurement signals respectively by the fitting models, so as to obtain a plurality of first fitting results that satisfy a first fitting condition.

In step S14, the first co-fitting procedure is to perform cursory fitting for a predetermined range of the target architecture. For example, when the target architecture is an NAND having four hundred material layers, the predetermined range can be odd-number layers of the four hundred material layers. As such, in step S14, the first co-fitting procedure is to perform fitting on structural parameters (e.g., the density, the thickness, and the roughness) of the odd-number layers.

In the first co-fitting procedure, a set of first to-be-verified parameters is generated according to the initial parameter ranges obtained in step S13, and this set of first to-be-verified parameters corresponds to the structural parameters within the above-mentioned predetermined range (i.e., two hundred layers out of the four hundred material layers). The set of first to-be-verified parameters is input into the above-mentioned fitting models to verify a first accuracy. For example, after the set of first to-be-verified parameters is input into the fitting models and fitting is performed by corresponding ones of the electromagnetic wave computation engines, one error amount and an N number of variances in the set of first to-be-verified parameters will be generated, and whether or not the error amount and the variances are lower than the initial fitting results will be determined.

If not, the set of first to-be-verified parameters is to be adjusted. Before another verification, adjustment is, for example, performed based on a random and staggered arrangement of the initial parameter ranges. Only when the first fitting condition is satisfied will the set of first to-be-verified parameters that satisfies the first fitting condition be configured as the first fitting results. For example, in order to satisfy the first fitting condition, the error amount and the variances are to be lower than the initial fitting results, and differences therebetween are to be greater than a predetermined value.

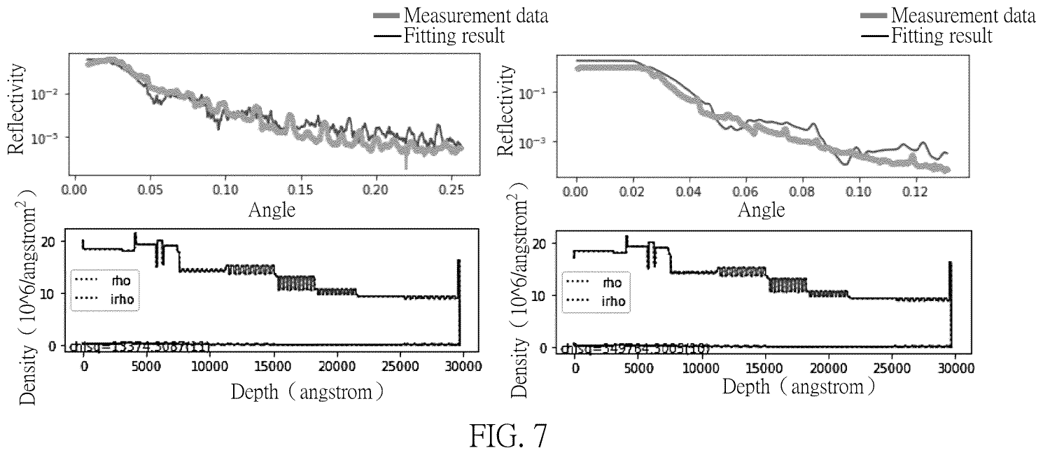

Reference is made to FIG. 7, which is a set of curve diagrams showing two first fitting results obtained after the first co-fitting procedure according to the first embodiment of the present disclosure. The two upper curve diagrams of FIG. 7 show relationships between angles and the X-ray measurement signals Sx and between the angles and reflectivities obtained through the first co-fitting procedure. In the two lower curve diagrams of FIG. 7, relationships between densities (which are divided into a real part rho and an imaginary part irho) and depths are shown, and data on a lower part thereof indicates the accuracy in the form of mean squared error (labelled as chisq). The respective accuracies are approximately 15374 and 349764 (with omission of decimals), and are decreased in comparison with the initial fitting results.

Step S15: performing, according to a data type of the first fitting results, a classification procedure on the first fitting results, so as to generate a plurality of classification fitting results.

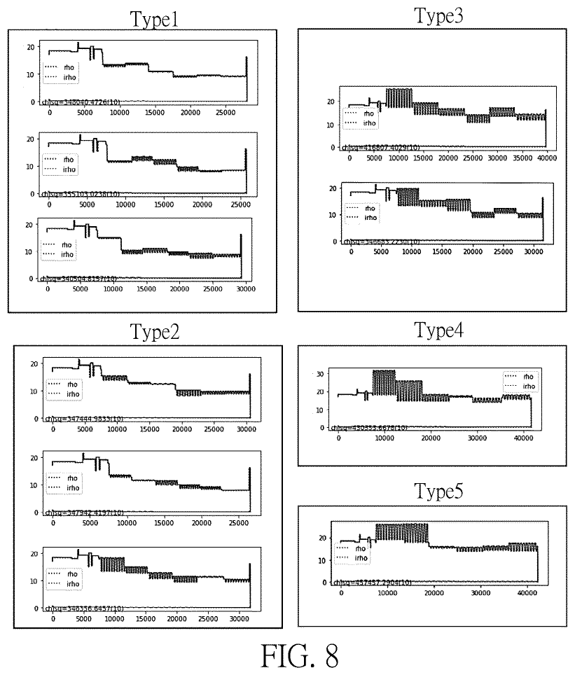

In this step, classification accuracies and efficiencies can be enhanced by using a decision tree algorithm together with machine learning. Specifically, the first fitting results generated in step S14 are input into a trained classification model for generation of the classification fitting results. The trained classification model is trained to classify the first fitting results by a decision tree analysis procedure or a regression tree analysis procedure, and a quantity of the first fitting results is greater than a quantity of the classification fitting results. For example, the decision tree analysis procedure or the regression tree analysis procedure can retrieve data features of the first fitting results (e.g., ups and downs, turning points, peak values, valley values, and other features of the curve diagram) through training. In this way, similarity clustering can be performed on the first fitting results. At the same time, ranking of the accuracies (which include the variances and the cost functions) is also performed to obtain a classification having a high accuracy. Hence, an optimal classification can be determined by the decision tree algorithm, such that the uncertainty of a fitting model architecture can be reduced. Reference is made to FIG. 8, which shows the classification fitting results obtained through the trained classification model according to the first embodiment of the present disclosure. Here, a change feature of the structural parameter (e.g., the density) relative to the depth is used as a classification criterion of the data type. However, the present disclosure is not limited thereto. Other structural parameters (e.g., the thickness and the roughness) can also be used as the classification criteria in step S15.

Step S16: counting the classification fitting results to obtain a plurality of classification parameter ranges.

Taking FIG. 8 as an example, the classification fitting results display five curve types after the classification in step S15, and five parameter ranges can be correspondingly obtained. Accordingly, a range of each structural parameter can be limited, such that the computation amount required for the fitting analysis can be significantly reduced. Furthermore, since the classification parameter ranges obtained in this step are generated based on results of the first co-fitting procedure, the accuracies thereof are already optimized.

Step S17: performing, according to the classification parameter ranges, a second co-fitting procedure on the X-ray measurement signals respectively by the fitting models, so as to obtain a plurality of second fitting results that satisfy a second fitting condition and respectively correspond to the structural parameters. In this step, the second co-fitting procedure is to perform the fitting analysis for an entire range of the target architecture. Even though a layer number to be calculated is increased as compared with that in the first co-fitting procedure, an overall computation amount can be significantly reduced since the ranges of the structural parameters to be calculated are already limited, and a certain accuracy can be maintained.

Similarly, in the second co-fitting procedure, a set of second to-be-verified parameters is generated according to the classification parameter ranges obtained in step S16, and then the set of second to-be-verified parameters is input into the above-mentioned fitting models to verify a second accuracy. For example, after the set of second to-be-verified parameters is input into the fitting models and fitting is performed by corresponding ones of the electromagnetic wave computation engines, one error amount and an N number of variances in the set of second to-be-verified parameters will be generated, and whether or not the error amount and the variances are lower than the first fitting results will be determined.

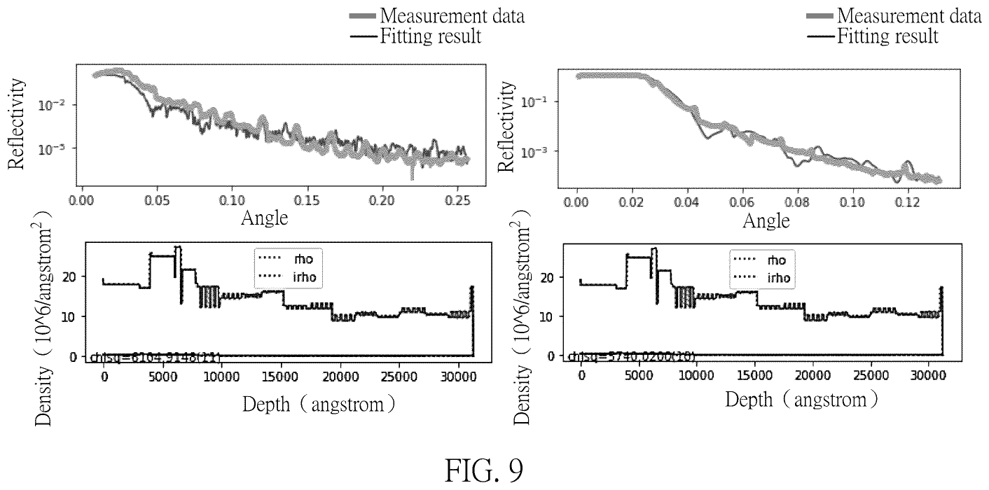

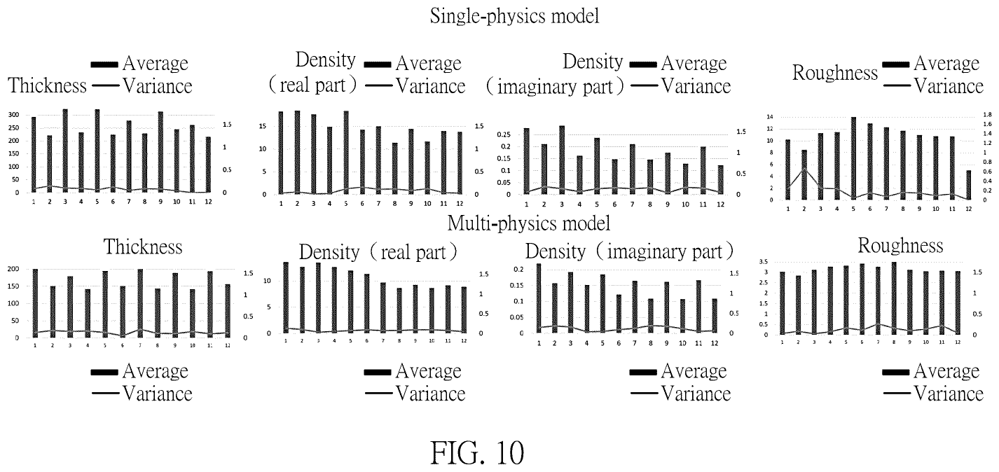

If not, the set of second to-be-verified parameters is to be adjusted. Before another verification, adjustment is, for example, performed based on a random and staggered arrangement of the classification parameter ranges. Only when the second fitting condition is satisfied will the set of second to-be-verified parameters that satisfies the second fitting condition be configured as the second fitting results (i.e., final fitting results). For example, in order to satisfy the second fitting condition, the error amount and the variances are to be lower than the first fitting results, and differences therebetween are to be greater than another predetermined value. Referring to FIG. 9 and FIG. 10, FIG. 9 shows two second fitting results through the second co-fitting procedure according to the first embodiment of the present disclosure, and FIG. 10 is a schematic diagram showing a comparison between an X-ray fitting analysis result according to the first embodiment of the present disclosure and a fitting analysis result of a single-physics model.

The two upper curve diagrams of FIG. 9 show relationships between angles and the X-ray measurement signals Sx (thick line) and between the angles and reflectivities (thin line) obtained through the second co-fitting procedure. In the two lower curve diagrams of FIG. 9, relationships between obtained densities (which are divided into a real part rho and an imaginary part irho) and depths are shown, and data on a lower part thereof indicates the accuracy in the form of mean squared error (labelled as chisq). The respective accuracies are approximately 6104 and 5740 (with omission of decimals), and are decreased in comparison with the initial fitting results and the first fitting results.

In comparison results of FIG. 10, comparisons are made with respect to the structural parameters, such as the thickness, the density (real part or imaginary part), and the roughness. An upper part of FIG. 10 is in relation to the single-physics model, and a lower part of FIG. 10 is in relation to a multi-physics model. Here, a histogram represents the averages, and a thin line represents the variances. It can be observed from FIG. 10 that the obtained variances will be smaller when calculation is made with the multi-physics model.

### Second Embodiment

A second embodiment of the present disclosure provides another X-ray fitting analysis system based on a multi-physics variable model. The X-ray fitting analysis system of the present embodiment has a system architecture that is essentially the same as that shown in FIG. 2 and FIG. 3. Since their difference resides in details of a fitting analysis, repetitive descriptions will be omitted herein.

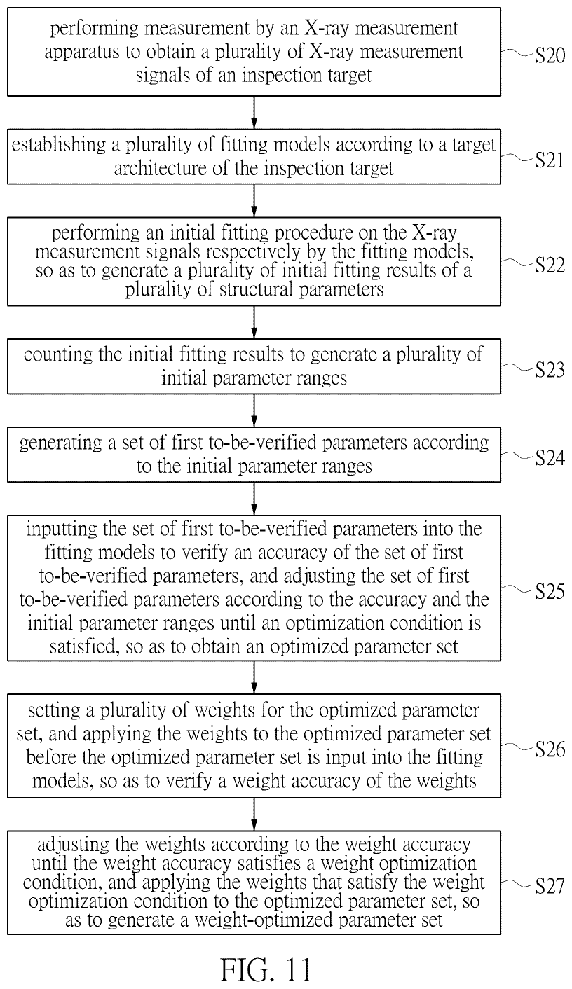

FIG. 11 is a flowchart of the X-ray fitting analysis method based on the multi-physics variable model according to the second embodiment of the present disclosure. Referring to FIG. 11, the X-ray fitting analysis method provided in the second embodiment of the present disclosure includes the following processes.
Step S20: performing measurement by an X-ray measurement apparatus to obtain a plurality of X-ray measurement signals of an inspection target.

Then, a processing device is configured to execute the following processes.
Step S21: establishing a plurality of fitting models according to a target architecture of the inspection target. As mentioned in the first embodiment, the target architecture is defined to include more than one structural parameter.
Step S22: performing an initial fitting procedure on the X-ray measurement signals respectively by the fitting models, so as to generate a plurality of initial fitting results of the structural parameters.
Step S23: counting the initial fitting results to generate a plurality of initial parameter ranges.
Step S24: generating a set of first to-be-verified parameters according to the initial parameter ranges.
Step S25: inputting the set of first to-be-verified parameters into the fitting models to verify an accuracy of the set of first to-be-verified parameters, and adjusting the set of first to-be-verified parameters according to the accuracy and the initial parameter ranges until an optimization condition is satisfied, so as to obtain an optimized parameter set.

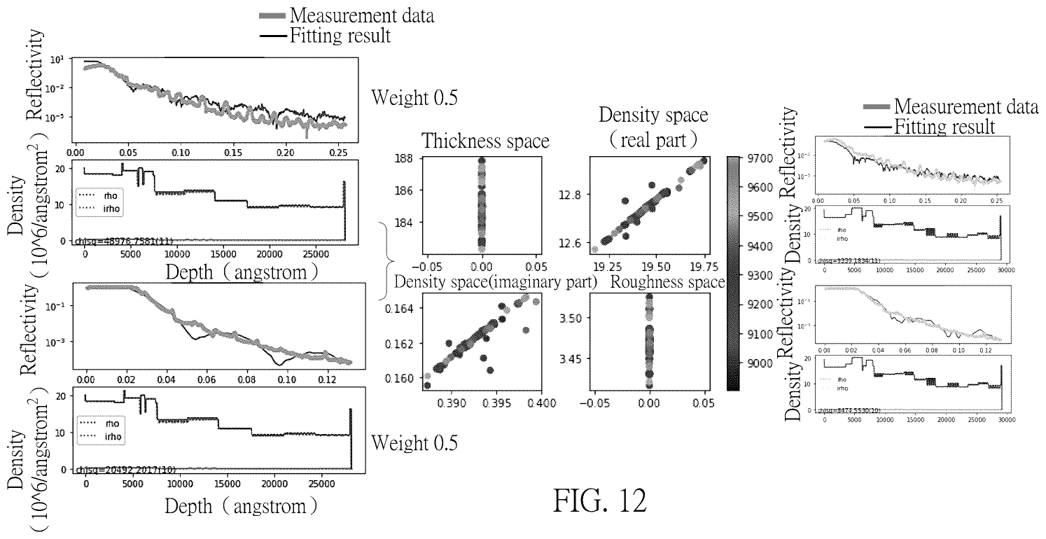

From step S23 to step S25, multiple sets of to-be-verified parameters can be generated according to the initial parameter ranges obtained in step S23, and are each input into the above-mentioned fitting models for accuracy verification. For example, each set of to-be-verified parameters is input into the fitting models, and fitting is performed by a corresponding electromagnetic wave computation engine, so as to generate an error amount and corresponding variances. Then, whether or not the error amount and the variances satisfy the optimization condition (e.g., the error amount is lower than a predetermined error amount, and the variances are lower than a predetermined variance) will be determined. If not, the set of to-be-verified parameters is to be adjusted. Before another verification, adjustment is, for example, performed based on a random and staggered arrangement of the initial parameter ranges. Only when the optimization condition is satisfied will the multiple sets of to-be-verified parameters be configured as the optimized parameter set.
Step S26: setting a plurality of weights for the optimized parameter set, and applying the weights to the optimized parameter set before the optimized parameter set is input into the fitting models, so as to verify a weight accuracy of the weights. For example, each set of to-be-verified parameters that satisfies the optimization condition includes the structural parameters (e.g., a thickness, a density, and a roughness) of each material layer of inspection target. Reference is made to FIG. 12, which is a schematic diagram showing a first iteration in step S26 according to the second embodiment of the present disclosure. During calculation of the first iteration, each set of to-be-verified parameters in the optimized parameter set is multiplied by a weight ranging between 0 and 1. It should be noted that a sum of all weights is 1. For example, there are two sets of to-be-verified parameters, and each of which is multiplied by a weight of 0.5, so as to obtain the optimized parameter set after application of the weights.

By inputting the set of to-be-verified parameters into the fitting models, a plurality of to-be-verified results are generated, and a plurality of parameter variances in each to-be-verified result and an error between the parameter variances and the X-ray measurement signals are determined for accuracy verification. It can be observed from distribution plots of a thickness space, a density space, and a roughness space shown at a center of FIG. 12 that results of the obtained structural parameters are divergent. Two fitting results and two density curve diagrams are shown on a right side of FIG. 12, and the obtained weight accuracies are displayed in the form of mean squared error (labelled as chisq). Since the respective weight accuracies are approximately 9339 and 8474 (with omission of decimals), there is still room for improvement on the weights. Furthermore, two new sets of to-be-verified parameters are generated during the first iteration, and can be used in a second iteration.
Step S27: adjusting the weights according to the weight accuracy until the weight accuracy satisfies a weight optimization condition, and applying the weights that satisfy the weight optimization condition to the optimized parameter set, so as to generate a weight-optimized parameter set.

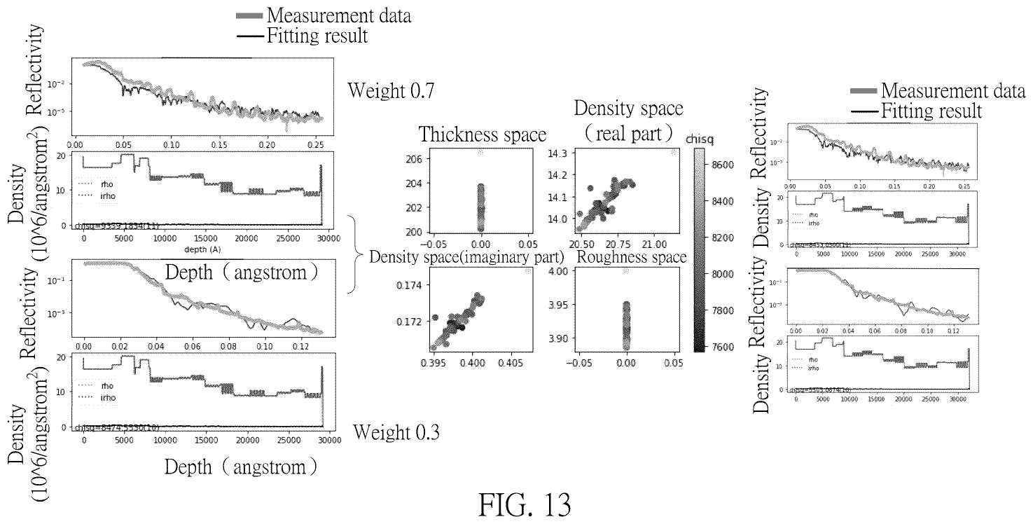

Reference is made to FIG. 13, which is a schematic diagram showing the second iteration in step S26 according to the second embodiment of the present disclosure. During calculation of the second iteration, another two sets of to-be-verified parameters generated in the first iteration can be respectively multiplied by weights of 0.7 and 0.3, so as to obtain the optimized parameter set after application of the weights.

Similarly, by inputting the two new sets of to-be-verified parameters into the fitting models, the to-be-verified results are generated, and the parameter variances in each to-be-verified result and the error between the parameter variances and the X-ray measurement signals are determined for accuracy verification. It can be observed from the distribution plots of the thickness space, the density space, and the roughness space shown at a center of FIG. 13 that results of the obtained structural parameters are more convergent as compared with those of the first iteration. This indicates that a weight distribution of 0.7 and 0.3 may be more preferable. Two fitting results and two density curve diagrams are shown on a right side of FIG. 13, and the obtained weight accuracies are displayed in the form of mean squared error (labelled as chisq). Since the respective weight accuracies are approximately 8453 and 5505 (with omission of decimals), the weight accuracies are more improved as compared with those of the first iteration.

If the weight accuracies reach a predetermined numerical range (e.g., the mean squared error is less than a specific value), the weight optimization condition is satisfied. The weights that satisfy the weight optimization condition are applied to the optimized parameter set for generating the weight-optimized parameter set, and this weight-optimized parameter set is defined to include the structural parameters that are obtained by the fitting analysis.

### Beneficial Effects of the Embodiments

In conclusion, in the X-ray fitting analysis method and the X-ray fitting analysis system based on the multi-physics variable model provided by the present disclosure, the cursory first co-fitting procedure is performed to classify the fitting results and limit the ranges of the structural parameters before the detailed second co-fitting procedure is performed. When the inspection target has a significant amount of material layers, the computation amount can be reduced while a certain fitting accuracy can be maintained, thereby ensuring the stability of the fitting models.

Furthermore, in the X-ray fitting analysis method and the X-ray fitting analysis system based on the multi-physics variable model provided by the present disclosure, a weight mechanism is further implemented, and the weights are optimized, so as to increase an optimization speed and reduce a degree of divergence of the fitting results.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An X-ray fitting analysis method based on a multi-physics variable model, comprising:
performing measurement by one or more X-ray measurement apparatuses to obtain a plurality of X-ray measurement signals of an inspection target; and
configuring a processing device to execute processes of;
establishing a plurality of fitting models according to a target architecture of the inspection target, wherein the target architecture is defined to include a plurality of structural parameters;
performing an initial fitting procedure on the plurality of X-ray measurement signals respectively by the plurality of fitting models, so as to generate a plurality of initial fitting results of the plurality of structural parameters;
counting the plurality of initial fitting results to generate a plurality of initial parameter ranges;
performing, according to the plurality of initial parameter ranges, a first co-fitting procedure on the plurality of X-ray measurement signals respectively by the plurality of fitting models, so as to obtain a plurality of first fitting results that satisfy a first fitting condition; wherein the first co-fitting procedure is to perform fitting for a predetermined range of the target architecture;
performing, according to a data type of the plurality of first fitting results, a classification procedure on the plurality of first fitting results, so as to generate a plurality of classification fitting results;
counting the plurality of classification fitting results to obtain a plurality of classification parameter ranges; and
performing, according to the plurality of classification parameter ranges, a second co-fitting procedure on the plurality of X-ray measurement signals respectively by the plurality of fitting models, so as to obtain a plurality of second fitting results that satisfy a second fitting condition and respectively correspond to the plurality of structural parameters; wherein the second co-fitting procedure is to perform a fitting analysis for an entire range of the target architecture.

2. The X-ray fitting analysis method according to claim 1, wherein performing measurement by the one or more X-ray measurement apparatuses to obtain the plurality of X-ray measurement signals of the inspection target includes: configuring one of the one or more X-ray measurement apparatuses to measure the inspection target with a plurality of different measurement conditions, or configuring different ones of the one or more X-ray measurement apparatuses to measure the inspection target.

3. The X-ray fitting analysis method according to claim 1, wherein each of the plurality of X-ray measurement signals includes one or more of a transmittance pattern, a reflection pattern, a diffraction pattern, and a scattering pattern, and each of the plurality of structural parameters includes one or more of a thickness, a density, and a roughness.

4. The X-ray fitting analysis method according to claim 1, wherein the target architecture includes a plurality of material layers; wherein the initial fitting procedure includes: using the processing device to operate an electromagnetic wave computation engine that corresponds to each of the plurality of fitting models, and performing a spectrum fitting analysis on a corresponding one of the plurality of X-ray measurement signals according to the target architecture, so as to obtain a corresponding one of the plurality of initial fitting results.

5. The X-ray fitting analysis method according to claim 1, wherein the first co-fitting procedure includes:
generating a set of first to-be-verified parameters according to the plurality of initial parameter ranges, wherein the set of first to-be-verified parameters corresponds to the plurality of structural parameters within the predetermined range; and
inputting the set of first to-be-verified parameters into the plurality of fitting models to verify a first accuracy of the set of first to-be-verified parameters, adjusting the set of first to-be-verified parameters according to the first accuracy and the plurality of initial parameter ranges until the first fitting condition is satisfied, and configuring the set of first to-be-verified parameters that satisfies the first fitting condition as the plurality of first fitting results.

6. The X-ray fitting analysis method according to claim 1, wherein the classification procedure includes:
inputting the plurality of first fitting results into a trained classification model for generation of the plurality of classification fitting results, wherein the trained classification model is trained to classify the plurality of first fitting results by a decision tree analysis procedure or a regression tree analysis procedure, and a quantity of the plurality of first fitting results is greater than a quantity of the plurality of classification fitting results.

7. The X-ray fitting analysis method according to claim 1, wherein the second co-fitting procedure includes:
generating a set of second to-be-verified parameters according to the plurality of classification parameter ranges, wherein the set of second to-be-verified parameters corresponds to the plurality of structural parameters within the entire range; and
inputting the set of second to-be-verified parameters into the plurality of fitting models to verify a second accuracy of the set of second to-be-verified parameters, adjusting the set of second to-be-verified parameters according to the second accuracy and the plurality of classification parameter ranges until the second fitting condition is satisfied, and configuring the set of second to-be-verified parameters that satisfies the second fitting condition as the plurality of second fitting results.

8. An X-ray fitting analysis method based on a multi-physics variable model, comprising:
performing measurement by one or more X-ray measurement apparatuses to obtain a plurality of X-ray measurement signals of an inspection target; and
configuring a processing device to execute processes of:
establishing a plurality of fitting models according to a target architecture of the inspection target, wherein the target architecture is defined to include a plurality of structural parameters;
performing an initial fitting procedure on the plurality of X-ray measurement signals respectively by the plurality of fitting models, so as to generate a plurality of initial fitting results of the plurality of structural parameters;
counting the plurality of initial fitting results to generate a plurality of initial parameter ranges;
generating a set of first to-be-verified parameters according to the plurality of initial parameter ranges;
inputting the set of first to-be-verified parameters into the plurality of fitting models to verify an accuracy of the set of first to-be-verified parameters, and adjusting the set of first to-be-verified parameters according to the accuracy and the plurality of initial parameter ranges until an optimization condition is satisfied, so as to obtain an optimized parameter set;
setting a plurality of weights for the optimized parameter set, and applying the plurality of weights to the optimized parameter set before the optimized parameter set is input into the plurality of fitting models, so as to verify a weight accuracy of the plurality of weights; and
adjusting the plurality of weights according to the weight accuracy until the weight accuracy satisfies a weight optimization condition, and applying the plurality of weights that satisfy the weight optimization condition to the optimized parameter set, so as to generate a weight-optimized parameter set.

9. The X-ray fitting analysis method according to claim 8, wherein the process of inputting the set of first to-be-verified parameters into the plurality of fitting models to verify the accuracy of the set of first to-be-verified parameters includes:
inputting the set of first to-be-verified parameters into the plurality of fitting models for generation of a plurality of to-be-verified results, and determining a plurality of parameter variances in each of the plurality of to-be-verified results and an error between the plurality of parameter variances and the plurality of X-ray measurement signals, so as to verify the accuracy.

10. The X-ray fitting analysis method according to claim 9, wherein each of the plurality of X-ray measurement signals includes one or more of a transmittance pattern, a reflection pattern, a diffraction pattern, and a scattering pattern, and each of the plurality of structural parameters includes one or more of a thickness, a density, and a roughness.

11. An X-ray fitting analysis system based on a multi-physics variable model, comprising:
one or more X-ray measurement apparatuses, wherein the one or more X-ray measurement apparatuses are configured to perform measurement on an inspection target for obtaining a plurality of X-ray measurement signals; and
a processing device configured to execute processes of:
establishing a plurality of fitting models according to a target architecture of the inspection target, wherein the target architecture is defined to include a plurality of structural parameters;
performing an initial fitting procedure on the plurality of X-ray measurement signals respectively by the plurality of fitting models, so as to generate a plurality of initial fitting results of the plurality of structural parameters;
counting the plurality of initial fitting results to generate a plurality of initial parameter ranges;
performing, according to the plurality of initial parameter ranges, a first co-fitting procedure on the plurality of X-ray measurement signals respectively by the plurality of fitting models, so as to obtain a plurality of first fitting results that satisfy a first fitting condition; wherein the first co-fitting procedure is to perform fitting for a predetermined range of the target architecture;
performing, according to a data type of the plurality of first fitting results, a classification procedure on the plurality of first fitting results, so as to generate a plurality of classification fitting results;
counting the plurality of classification fitting results to obtain a plurality of classification parameter ranges; and
performing, according to the plurality of classification parameter ranges, a second co-fitting procedure on the plurality of X-ray measurement signals respectively by the plurality of fitting models, so as to obtain a plurality of second fitting results that satisfy a second fitting condition and respectively correspond to the plurality of structural parameters; wherein the second co-fitting procedure is to perform a fitting analysis for an entire range of the target architecture.

12. The X-ray fitting analysis system according to claim 11, wherein performing measurement by the one or more X-ray measurement apparatuses to obtain the plurality of X-ray measurement signals of the inspection target includes: configuring one of the one or more X-ray measurement apparatuses to measure the inspection target with a plurality of different measurement conditions, or configuring different ones of the one or more X-ray measurement apparatuses to measure the inspection target.

13. The X-ray fitting analysis system according to claim 11, wherein each of the plurality of X-ray measurement signals includes one or more of a transmittance pattern, a reflection pattern, a diffraction pattern, and a scattering pattern, and each of the plurality of structural parameters includes one or more of a thickness, a density, and a roughness.

14. The X-ray fitting analysis system according to claim 11, wherein the target architecture includes a plurality of material layers; wherein the initial fitting procedure includes: using the processing device to operate an electromagnetic wave computation engine that corresponds to each of the plurality of fitting models, and performing a spectrum fitting analysis on a corresponding one of the plurality of X-ray measurement signals according to the target architecture, so as to obtain a corresponding one of the plurality of initial fitting results.

15. The X-ray fitting analysis system according to claim 11, wherein the first co-fitting procedure includes:
generating a set of first to-be-verified parameters according to the plurality of initial parameter ranges, wherein the set of first to-be-verified parameters corresponds to the plurality of structural parameters within the predetermined range; and
inputting the set of first to-be-verified parameters into the plurality of fitting models to verify a first accuracy of the set of first to-be-verified parameters, adjusting the set of first to-be-verified parameters according to the first accuracy and the plurality of initial parameter ranges until the first fitting condition is satisfied, and configuring the set of first to-be-verified parameters that satisfies the first fitting condition as the plurality of first fitting results.

16. The X-ray fitting analysis system according to claim 11, wherein the classification procedure includes:
inputting the plurality of first fitting results into a trained classification model for generation of the plurality of classification fitting results, wherein the trained classification model is trained to classify the plurality of first fitting results by a decision tree analysis procedure or a regression tree analysis procedure, and a quantity of the plurality of first fitting results is greater than a quantity of the plurality of classification fitting results.

17. The X-ray fitting analysis system according to claim 11, wherein the second co-fitting procedure includes:
generating a set of second to-be-verified parameters according to the plurality of classification parameter ranges, wherein the set of second to-be-verified parameters corresponds to the plurality of structural parameters within the entire range; and
inputting the set of second to-be-verified parameters into the plurality of fitting models to verify a second accuracy of the set of second to-be-verified parameters, adjusting the set of second to-be-verified parameters according to the second accuracy and the plurality of classification parameter ranges until the second fitting condition is satisfied, and configuring the set of second to-be-verified parameters that satisfies the second fitting condition as the plurality of second fitting results.

18. An X-ray fitting analysis system based on a multi-physics variable model, comprising:
one or more X-ray measurement apparatuses, wherein the one or more X-ray measurement apparatuses perform measurement to obtain a plurality of X-ray measurement signals of an inspection target; and
a processing device configured to execute processes of:
establishing a plurality of fitting models according to a target architecture of the inspection target, wherein the target architecture is defined to include a plurality of structural parameters;
performing an initial fitting procedure on the plurality of X-ray measurement signals respectively by the plurality of fitting models, so as to generate a plurality of initial fitting results of the plurality of structural parameters;
counting the plurality of initial fitting results to generate a plurality of initial parameter ranges;
generating a set of first to-be-verified parameters according to the plurality of initial parameter ranges;
inputting the set of first to-be-verified parameters into the plurality of fitting models to verify an accuracy of the set of first to-be-verified parameters, and adjusting the set of first to-be-verified parameters according to the accuracy and the plurality of initial parameter ranges until an optimization condition is satisfied, so as to obtain an optimized parameter set;
setting a plurality of weights for the optimized parameter set, and applying the plurality of weights to the optimized parameter set before the optimized parameter set is input into the plurality of fitting models, so as to verify a weight accuracy of the plurality of weights; and
adjusting the plurality of weights according to the weight accuracy until the weight accuracy satisfies a weight optimization condition, and applying the plurality of weights that satisfy the weight optimization condition to the optimized parameter set, so as to generate a weight-optimized parameter set.

19. The X-ray fitting analysis system according to claim 18, wherein the process of inputting the set of first to-be-verified parameters into the plurality of fitting models to verify the accuracy of the set of first to-be-verified parameters includes:
inputting the set of first to-be-verified parameters into the plurality of fitting models for generation of a plurality of to-be-verified results, and determining a plurality of parameter variances in each of the plurality of to-be-verified results and an error between the plurality of parameter variances and the plurality of X-ray measurement signals, so as to verify the accuracy.

20. The X-ray fitting analysis system according to claim 19, wherein each of the plurality of X-ray measurement signals includes one or more of a transmittance pattern, a reflection pattern, a diffraction pattern, and a scattering pattern, and each of the plurality of structural parameters includes one or more of a thickness, a density, and a roughness.
